(19) United States
(12) Patent Application Publication
(10) Pub. No.: US 2010/0107503 A1
(43) Pub. Date: May 6, 2010

(54) ASTRAGAL WITH EXPANDABLE BOOT

(75) Inventor: Gabriel Paul Chapman, Atlanta, GA (US)

Correspondence Address: SUTHERLAND ASBILL & BRENNAN LLP, 999 PEACHTREE STREET, N.E., ATLANTA, GA, 30309, US

(73) Assignee: GLOBAL PRODUCTS, LLC, Atlanta, GA (US)

(21) Appl. No.: 12/263,678

(22) Filed: Nov. 3, 2008

(51) Int. Cl. E06B 5/00

(52) U.S. Cl. 49/365

(57) ABSTRACT

A system may selectively block an area at an end of an astragal. The system may include an expandable boot and an actuator. The expandable boot may be positioned at the end of the astragal, and the expandable boot may be movable between a compacted shape and an expanded shape. The actuator may be operable to move the expandable boot between the compacted shape and the expanded shape.

### TECHNICAL FIELD

The present disclosure generally relates to an astragal for closing a space between two double doors, and more particularly relates to an astragal having an expandable boot for selectively blocking a relief area below the astragal.

### BACKGROUND

Double doors are common in homes and buildings. Typically, a set of double doors includes an inactive door and an active door. The two doors are positioned adjacent to each other within a common door frame. Although both doors are capable of opening, the active door is generally used for routine ingress and egress, while the inactive door is generally kept closed and is only opened in special cases, such as when a wider opening is desired.

The inactive door is usually associated with an astragal, which is a jamb-like structure extending along a free edge of the inactive door, opposite from a hinged edge. Embodiments of astragals are disclosed in U.S. Pat. No. 5,350,207 to Sanders and U.S. Publication No. 2005/0116424 by Sanders, each of which is incorporated by reference. The astragal may facilitate locking the inactive door in a closed position. For example, the astragal may house upper and lower locking bolts that are operatively connected to a lever or other actuator. When the lever is engaged, the bolts may extend into corresponding wells in the door frame to lock the inactive door against the door frame. The lever may also retract the bolts from the wells to unlock the inactive door.

The astragal also may facilitate locking the active door against the inactive door. For example, the astragal may have a flange that forms a stop for capturing the active door as it closes. The astragal may also have an opening surrounded by a strike plate, and the active door may have a door knob with a bolt. When the active door is closed, the bolt of the active door may enter the opening in the astragal to hold the active door closed against the astragal.

The astragal may also form a seal between the two doors when the active door is closed, to reduce the passage of air, light, water, debris, and critters into the home or building. For example, the astragal may provide a mounting surface for a sealing member such as weather stripping.

The astragal may be coupled to the inactive door and may move with the inactive door as the inactive door opens and closes. To permit such movement, the astragal may not extend all the way to the floor. Instead, the astragal may be slightly spaced apart from a lower sill of the door frame, forming a small relief area. The relief area may permit the astragal to move with the inactive door without contacting the lower sill of the door frame or the floor.

One common problem is that the relief area provides a point of access into the home or building for air, light, water, debris and critters. To limit such access, the lower end of the astragal may be fitted with a boot or other closure piece. Typically, the boot is a sealing structure formed from a flexible material such as rubber. The boot may limit ingress through the relief area without limiting movement of the door, such as by partially but not completely filling the relief area. An embodiment of a boot is illustrated in U.S. Design Pat. No. D544,337 to Pepper et al., which issued on Jun. 12, 2007.

Although the boot may partially fill the relief area, the boot presents problems of its own. For example, the height of the relief area may vary widely, depending on variations and inaccuracies in the double door installation. For example, the inactive door may be hung too low, or adjacent portions of the lower sill or floor may be sloped. If the inactive door is hung too low or if the floor slopes upward away from the door frame, the boot may scrape against the floor as the inactive door is opened. On the other hand, if the inactive door is hung too far from the floor, the boot may not sufficiently fill the relief area, and ingress may be permitted. The boot may also sag, crumble, deteriorate, or otherwise fail with the passage of time, which may result from abrasion against the lower sill of the door frame.

One proposed alternative is a movable boot of the type described in U.S. Pat. No. 5,857,291 to Headrick, which is incorporated by reference. Such a movable boot may be moved into and out of the relief area, to fill or vacate the relief area as appropriate. One issue with the movable boot is that its size is fixed, meaning that the movable boot may only be suited for filling a relief area of a corresponding size. In other words, the movable boot may not be appropriately sized to fill relief areas of non-standard heights, which may be common due to variations or inaccuracies in installation. Another issue with the movable boot is that it may be difficult to operate. Specifically, the moveable boot may be lowered and locked by sliding a hand slide and twisting a recessed knob, which may be cumbersome for some, such as a lady with longer fingernails or a person with arthritis. The moveable boot also may not be adequately held against the sill to form a seal.

From the above, it is apparent that a need exists for a boot that can selectively close a relief area between an astragal and a lower surface, including relief areas of varying sizes.

### SUMMARY

Described below is a system that may selectively block an area at an end of an astragal. The system may include an expandable boot and an actuator. The expandable boot may be positioned at the end of the astragal, and the expandable boot may be movable between a compacted shape and an expanded shape. The actuator may be operable to move the expandable boot between the compacted shape and the expanded shape.

Also described below is an astragal that may include an astragal jamb member, an expandable boot and an actuating member. The expandable boot may be coupled to an end of the astragal jamb member, and the expandable boot may be movable between a compacted shape and an expanded shape. The actuating member may extend from an end of the astragal, and the actuating member may be movable between a retracted position and an extended position. The actuating member may expand the expandable boot as the actuating member moves from the retracted position to the extended position.

Other systems, devices, methods, features, and advantages of the disclosed astragal with expandable boot will be apparent or will become apparent to one with skill in the art upon examination of the following figures and detailed description. All such additional systems, devices, methods, features, and advantages are intended to be included within the description and are intended to be protected by the accompanying claims.

### BRIEF DESCRIPTION OF THE FIGURES

The present disclosure may be better understood with reference to the following figures. Matching reference numerals designate corresponding parts throughout the figures, and components in the figures are not necessarily to scale.

FIG. 1 is a perspective view of an embodiment of an astragal, illustrating the astragal positioned between double doors.

FIG. 2 is a top cross-sectional view of the embodiment of the astragal shown in FIG. 1, taken along line 2-2, illustrating the astragal positioned between double doors in a closed position.

FIG. 3 is a partial side cross-sectional view of the embodiment of the astragal shown in FIG. 1, illustrating an expandable boot of the astragal in the compacted shape.

FIG. 4 is a another partial side cross-sectional view of the embodiment of the astragal shown in FIG. 1, illustrating the expandable boot as it assumes the expanded shape.

FIG. 5 is another partial side cross-sectional view of the embodiment of the expandable boot shown in FIG. 1, illustrating the expandable boot after achieving the expanded shape.

FIG. 6 is a top cross-sectional view of the embodiment of the astragal shown in FIG. 1, taken along line 6-6, illustrating a profile of an embodiment of the expandable boot.

FIG. 7 is a partial side cross-sectional view of another embodiment of an astragal, illustrating an expandable boot of the astragal in a compacted shape.

FIG. 8 is a partial side cross-sectional view of the embodiment of an astragal shown in FIG. 7, illustrating the expandable boot of the astragal in an expanded shape.

### DETAILED DESCRIPTION

Described below are embodiments of an astragal with an expandable boot. The astragal may be associated with an inactive door of a double door set. The expandable boot may be positioned on a lower end of the astragal adjacent to a sill of the door frame. The expandable boot may be selectively expanded and compacted. More specifically, the expandable boot may be expanded to substantially fill a relief area between the astragal and the lower sill of the door frame, to impede the passage of air, light, water, debris, and critters through the relief area. The expandable boot also may be at least partially removed from the relief area, so that the inactive door may be opened. The expandable boot may variably expand to fill relief areas of varying heights, which may be desirable in view of inaccuracies and variations associated with the double door installation.

In embodiments, the expandable boot may be operatively associated with a locking mechanism, which is otherwise employed to selectively lock the inactive door against the sill. In such embodiments, locking the inactive door may simultaneously expand the expandable boot to fill the relief area, while unlocking the inactive door may simultaneously compact the expandable boot to at least partially void the relief area. Thus, the relief area may be substantially filled by the expandable boot when the inactive door is locked, so that air, light, water, and other matter are blocked from passing through the relief area. However, the relief area may be at least partially unblocked by the expandable boot when the inactive door is unlocked, so that the inactive door may be opened without scraping the expandable boot against the lower sill of the door frame or the floor.

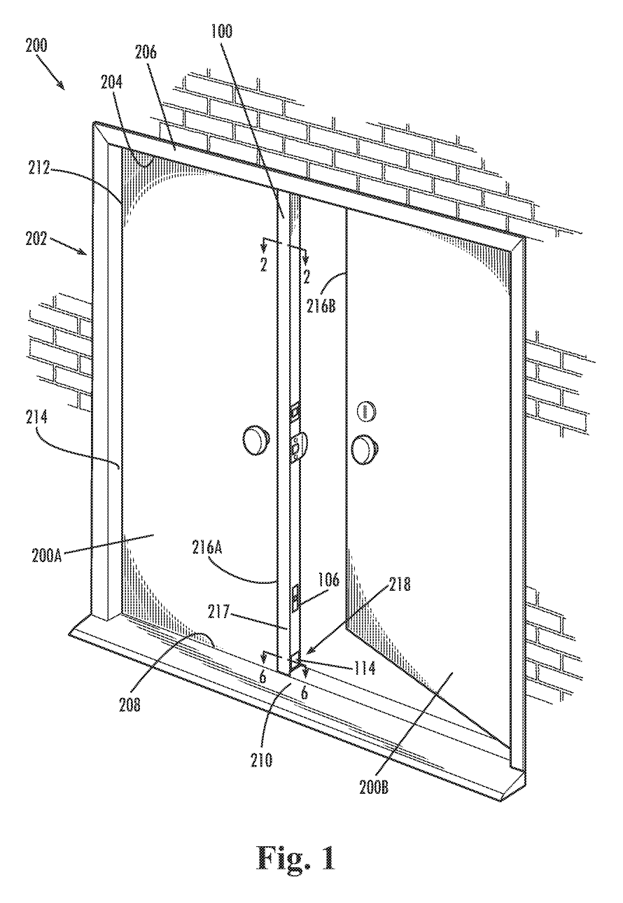

FIG. 1 is a perspective view of an embodiment of an astragal 100, illustrating the astragal 100 positioned between a set of double doors 200. As shown, the double doors 200 generally include an inactive door 200A and an active door 200B. The doors 200 are positioned adjacent to each other within a common door frame 202. More specifically, each door 200 may include an upper edge 204 that abuts the door frame 202 about an upper jamb head 206, a lower edge 208 positioned adjacent to the door frame 202 near a lower sill 210, an outside or hinged edge 212 that is mounted to the door frame 202 along a vertical jamb 214, and an inner or free edge 216 located opposite from the outside or hinged edge 212.

Extending along the free edge 216A of the inactive door 200A is the astragal 100. The astragal 100 may include an astragal jamb 217, which may be, for example, an extruded member formed from aluminum, vinyl, fiberglass, plastic or wood, among others or combinations thereof. The astragal jamb 217 may be coupled to the free edge 216A of the inactive door 200A and may move with the inactive door 200A. To accommodate such movement, a relief area 218 may be formed below the astragal 100, which permits the astragal 100 to move with the inactive door 200A without dragging against the lower sill 210 of the door frame 202 or the floor. The relief area 218 may have a height that varies depending on the double door installation. For example, the relief area 218 may have a height in the range of about 0.25 inches to about 0.75 inches, although other dimensions are possible. As shown, the relief area 218 may be occupied by an expandable boot 114 associated with the astragal 100. The expandable boot 114 may at least partially block, fill, close, or otherwise occupy the relief area 218 to prevent or impede access through the relief area 218. The expandable boot 114 may be operated via an actuator, which may be a locking mechanism 106 that is otherwise adapted to lock the inactive door 200A against the lower sill 210.

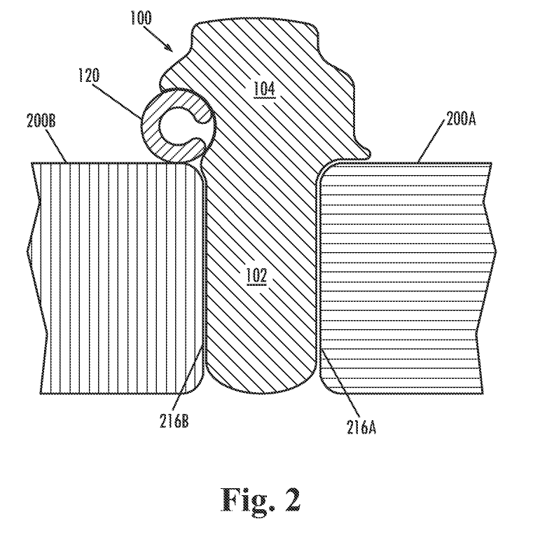

FIG. 2 is a top cross-sectional view of the embodiment of the astragal 100 shown in FIG. 1, taken along line 2-2. As shown in FIG. 2, the astragal 100 may form a seal between the two doors 200 when both of the doors 200 are closed. More specifically, the astragal 100 may include a rearward or inner portion 102 that becomes captured between the two doors 200 when the doors 200 are closed, and a forward or outer portion 104 that remains exposed outside of the doors 200 when the doors 200 are closed. Thus, the astragal 100 may limit passage through the doors by filling a space between the doors 200 with the rearward or inner portion 102 and by extending over the free edges 216 and a portion of the door surfaces with the forward or outer portion 104. Due to this shape, the astragal 100 may be referred to as a T-astragal. In most cases, the outer portion 104 of the astragal 100 directly abuts the inactive door 200A, while the outer portion 104 astragal 100 indirectly abuts the active door 200B via a weather stripping or other flexible seal 120, as shown.

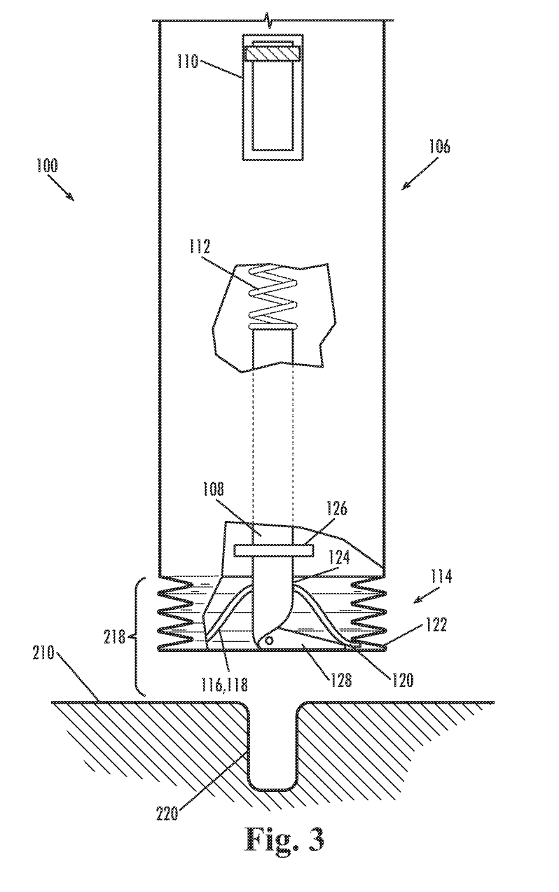

With reference to FIG. 3, the astragal 100 may include a locking mechanism 106 suited for locking the inactive door 200A in a closed position. For example, the astragal 100 may house an actuating member, such as a locking bolt 108, that is operatively connected to an actuator 110. The actuator 110 may be, for example, a lever, a slider, a button, or a switch, among others or combinations of these and others. The actuator 110 may be engaged to move the locking bolt 108 between an extended position and a retracted position. In the extended position, the locking bolt 108 may extend into a receiving well 220 in the lower sill 210 to hold the inactive door 200A closed. In the retracted position, the locking bolt 108 may be retracted into the astragal 100 so that the inactive door 200A may be opened.

In the illustrated embodiment, the locking bolt 108 is positioned on a lower end of the astragal 100, and the receiving well 220 is formed in the lower sill 210. In other embodiments, locking bolts 108 may be positioned on lower and upper ends of the astragal 100, and corresponding receiving wells 220 may be formed in both the lower sill 210 and the upper jamb head 206. In such embodiments, the locking bolts 108 may employ a shared actuator or independent actuators. In still other embodiments, the locking bolt 108 may be positioned on the upper end of the astragal 100 but not on the lower end of the astragal 100, in which case the actuator 110 may extend or retract the locking bolt 108 from a receiving well 220 in the upper jamb head 206 alone.

The actuator 110 may receive an actuating force from a user and may transfer the actuating force to the locking bolt 108, causing the locking bolt 108 to translate between the extended and retracted positions. In embodiments, the actuator 110 may amplify the actuating force applied by the user. For example, the actuator 110 may include a spring 112. When the actuator 110 is engaged to unlock the inactive door 200A, the actuating force may cause the locking bolt 108 to retract while simultaneously loading the spring 112. When the actuator 110 is engaged to lock the inactive door 200A, the actuating force may release the spring 112, which may drive the locking bolt 108 into the receiving well 220 to lock the inactive door 200A against the lower sill 210. Due to the release of the spring 112, the driving force applied to the locking bolt 108 may exceed the actuating force applied to the actuator 110 by the user. In such cases, locking the inactive door 200A may be relatively less difficult than unlocking the inactive door 200A, as locking the inactive door 200A may employ the assisting force of the spring 112.

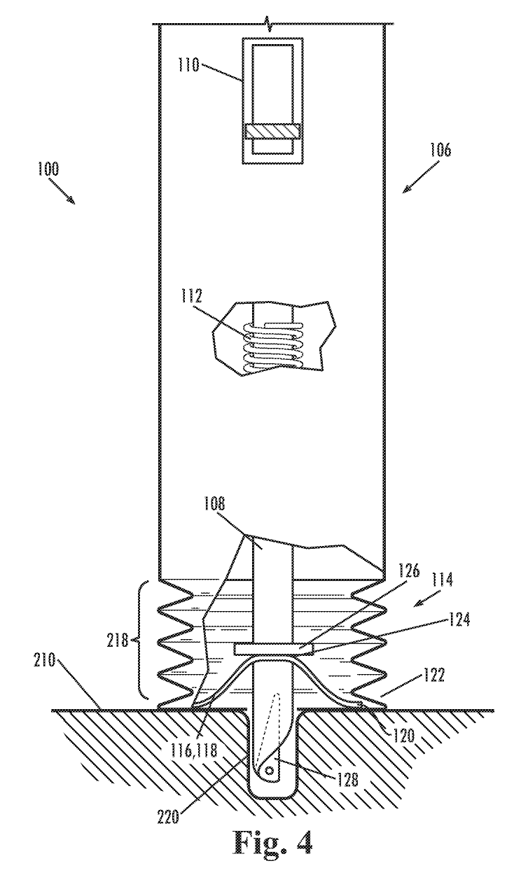

As shown, the astragal 100 may include an expandable boot 114 positioned adjacent to the relief area 218. The expandable boot 114 may be coupled to a lower end of the astragal 100, as shown. For example, an upper edge of the expandable boot 114 may be affixed to a lower edge of the astragal 100, although other configurations are possible. The expandable boot 114 may be adapted to expand or contract, so that the expandable boot 114 may selectively fill or vacate the relief area 218 as desired. More specifically, the expandable boot 114 may be movable between a compacted shape in which the expandable boot 114 at least partially voids the relief area 218, as shown in FIG. 3, and an expanded shape in which the expandable boot 114 at least partially fills the relief area 218, as shown in FIG. 4. For example, the expandable boot 114 may substantially fill, close, or block the relief area 218 when in the expanded shape.

The expandable boot 114 may have any configuration that enables filling relief areas 218 of varying sizes. In other words, the expandable boot 114 may not have a fixed or finite height when in the expanded shape. Instead, the expandable boot 114 may have a variable height. When the expandable boot 114 is in the expanded shape, the boot 114 may assume a height that substantially matches the height of the relief area 218, so that the boot 114 substantially fills the relief area 218. For example, the expandable boot 114 may have walls that are accordion shaped, in which case a body of the expandable boot 114 may be a substantially hollow bellows. In such cases, the expandable boot 114 may be formed from a flexible material, such as rubber or other elastomeric material. In other cases, the expandable boot 114 may have other shapes or configurations that permit varying the height of the boot 114 to substantially fill the relief area 218. For example, the expandable boot 114 may be formed from a series of interconnected telescoping members as described below with reference to FIGS. 7 and 8, among other configurations.

In embodiments, the expandable boot 114 may be operatively connected to the locking mechanism 106 that locks the inactive door 200A against the lower sill 210A. In such embodiments, locking the locking mechanism 106 may simultaneously expand the expandable boot 114 until the relief area 218 is substantially filled. Similarly, unlocking the locking mechanism 106 may simultaneously compress the expandable boot 114 until a void is formed in the relief area 218. To accomplish such a configuration, the expandable boot 114 may house a flexible transfer structure 116. The flexible transfer structure 116 may be adapted to transfer movement of the locking bolt 108 to the expandable boot 114. More specifically, the flexible transfer structure 116 may be adapted to transfer movement of the locking bolt 108 to the expandable boot 114 until the relief area 218 is filled, and to absorb movement of the locking bolt 108 thereafter. Thus, the flexible transfer structure 116 may facilitate expanding the expandable boot 114 until the relief area 218 is filled.

The flexible transfer member 116 may be an internal spring 118, as shown in FIGS. 3-5. The internal spring 118 may be generally semi-cylindrically shaped and may be formed from a flexible material, such as a thin sheet of metal. As shown in the illustrated embodiment, the internal spring 118 may have feet 120 that project outward from its peripheral edges. The feet 120 may be positioned in receiving folds 122 formed adjacent to a lower walls of the expandable boot 114. In some cases, the feet 120 may be movably positioned within the receiving folds 122, so that the feet 120 may travel laterally as the internal spring 118 flexes, while in other cases the feet 120 may be directly or indirectly coupled to the receiving folds 122 or other portions of the expandable boot 114. In other embodiments, the feet 120 may be omitted, in which case peripheral edges of the internal spring 118 may be rest against or be coupled to walls of the expandable boot 114. In still other embodiments, the flexible transfer structure 116 may any shape or configuration, or may be omitted completely.

So that the internal spring 118 is operatively associated with the locking mechanism 106, the locking bolt 108 may extend through a hole 124 formed through the internal spring 118. Above the hole 124, the locking bolt 108 may have a projecting rim 126. The projecting rim 126 may have diameter that exceeds the diameter of the hole 124, so that the projecting rim 126 may engage and disengage the internal spring 118 as the locking bolt 108 travels through the hole 124.

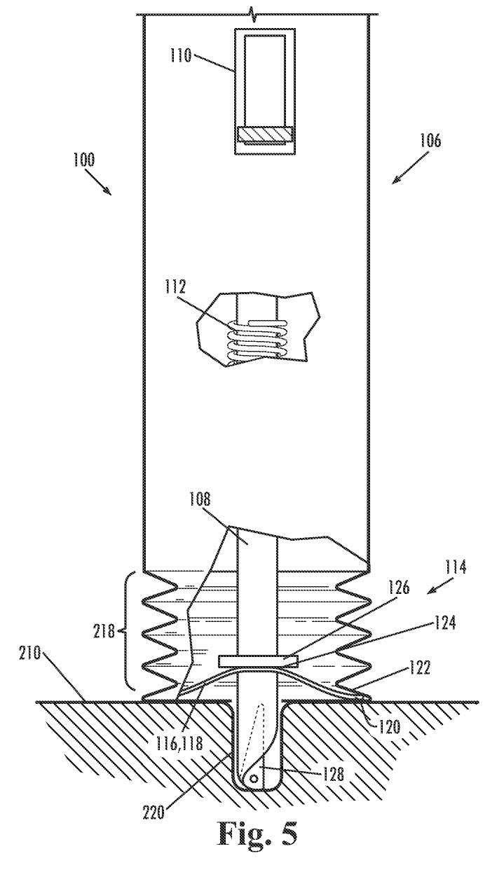

The operation of the expandable boot is described below with reference to FIGS. 3-5, which illustrate the relationship between the expandable boot 114 and the locking bolt 108 as the inactive door 200A is locked, meaning as the locking bolt 108 moves from the retracted position to the extended position. When the inactive door 200A is unlocked as shown in FIG. 3, the expandable boot 114 is in the compressed shape, the locking bolt 108 is in the retracted position, and the internal spring 118 is at rest. The projecting rim 126 of the locking bolt 108 may be positioned above the internal spring 118, slightly spaced apart from the hole 124, and the feet 120 of the internal spring 118 may be positioned within the receiving folds 122 slightly spaced apart from their walls. When the inactive door 200A is locked as shown in FIG. 5, the expandable boot 114 is in the expanded shape, the locking bolt 108 is in the extended position, and the internal spring 118 is loaded. The projecting rim 126 of the locking bolt 108 may press against the internal spring 118 about the hole 124, and the feet 120 of the internal spring 118 may contact the expandable boot 114 to hold the boot 114 down.

To move the expandable boot 114 from the compressed shape to the expanded shape, the inactive door 200A may be locked. More specifically, the actuator 110 of the locking mechanism 106 may be engaged. Engaging the actuator 110 may impart a driving force on the locking bolt 108 that causes the locking bolt 108 to translate downward. With downward translation, the projecting rim 126 of the locking bolt 108 may contact the internal spring 118. The locking bolt 108 may transfer a portion of the driving force to the internal spring 118 through the projecting rim 126. In turn, the internal spring 118 may transfer a portion of the driving force to the expandable boot 114, causing the walls of the expandable boot 114 to extend downward. For example, the feet 120 of the internal spring 118 may engage the receive folds 122 to cause the walls of the expandable boot 114 to extend from the accordion shape. The expandable boot 114 may continue such expansion until the lower wall of the expandable boot 114 contacts the lower sill 210, as shown in FIG. 4. Thus, the expandable boot 114 may be expanded to a variable height, and the relief area 218 may be substantially filled.

With continued downward translation of the locking bolt 108, the internal spring 118 may flex to absorb the force imparted by the projecting rim 126, as shown in FIG. 5. The feet 120 of the internal spring 118 also may translate outward to contact the receiving folds 122. The locking bolt 108 may become firmly seated in the receiving well 220, so that the inactive door 200A is locked. The internal spring 118 may become captured between the projecting rim 126 and the lower sill 210 to hold the expandable boot 114 down, such that the relief area 218 is filled and a tight seal is formed.

In embodiments in which the locking mechanism 106 includes a spring 112 as described above, the spring 112 may facilitate sealing the expandable boot 114 against the lower sill 210. For example, the spring 112 may force the projecting rim 126 against the internal spring 118 of the expandable boot 114, as shown in FIG. 5. Thus, the internal spring 118 may be partially loaded, such that the internal spring 118 holds the expandable boot 114 against the lower sill 210. However, other configurations are possible in other embodiments.

With reference back to FIG. 3, the expandable boot 114 may be maintained in the compacted shape when the inactive door 200A is unlocked. Further, the expandable boot 114 may be moved from the expanded shape to the compacted shape as the inactive door 200A is unlocked, meaning as the locking bolt 108 moves from the extended position to the retracted position. For such reasons, an end of the locking bolt 108 may be fitted with a movable tip 128, which may assist with compacting the expandable boot 114 and maintaining the boot 114 in the compacted shape.

More specifically, the movable tip 128 may be movable between an outwardly projecting position, in which the tip 128 projects laterally outward from a central axis of the locking bolt 108 as shown in FIG. 3, and an upwardly projecting position, in which the tip 128 projects longitudinally upward along the central axis of the locking bolt 108, as shown in FIG. 5. In embodiments, the tip 128 may be normally maintained in the outwardly projecting position, such as via a small spring near the tip 128.

When the locking bolt 108 is in the retracted position as shown in FIG. 5, the tip 128 may be in the outwardly projecting position. Thus, the tip 128 may engage the expandable boot 114 to maintain the expandable boot 114 in the compacted position. For example, the tip 128 may contact a lower surface of the internal spring 118. As the locking bolt 108 translates downward into the extended position, the tip 128 may contact the lower sill 210, causing the tip 128 to rotate upward into the upwardly projecting position. Thus, when the locking bolt 108 is in the extended position as shown in FIG. 5, the tip 128 may fit within the receiving well 220. As the locking bolt 108 translates upward into the retracted position, the tip 128 may become removed from the receiving well 220 and may return to the outwardly projecting position under the force of the spring, or alternatively, under the force of gravity. With continued upward movement of the locking bolt 108, the tip 128 may catch against expandable boot 114 to pull the expandable boot 114 into the compacted shape. For example, the tip 128 may contact and pull the internal spring 118 upward, which may raise the walls of the expandable boot 114, such as through the interaction of the feet 120 with the receiving folds 122. Thus, retracting the locking bolt 108 from the receiving well 220 may simultaneously compact the expandable boot 114 into the compacted shape so that a void is formed in the relief area 218. Thereafter, the expandable boot 114 may be maintained in the compacted shape until the actuator 110 is again engaged to translate the locking bolt 108 downward.

As described above, the expandable boot 114 may be operatively coupled to the locking mechanism 106 of the inactive door 200A. In other embodiments, the expandable boot 114 may have its own actuator. The actuator may be separate from the locking mechanism 106, in which case the locking mechanism 106 may or may not be provided. Further, the expandable boot 114 may be positioned on an upper end of the astragal 100 in other embodiments. In such cases, the expandable boot 114 may close a relief area above the astragal 100 adjacent to the upper jamb head 206 of the door frame 202. In still other embodiments, the astragal 100 may have expandable boots on both upper and lower ends of the astragal, in which case both expandable boots may be associated with the same or different actuators, which actuators may or may not be the same as the actuators that operate the locking bolt or bolts.

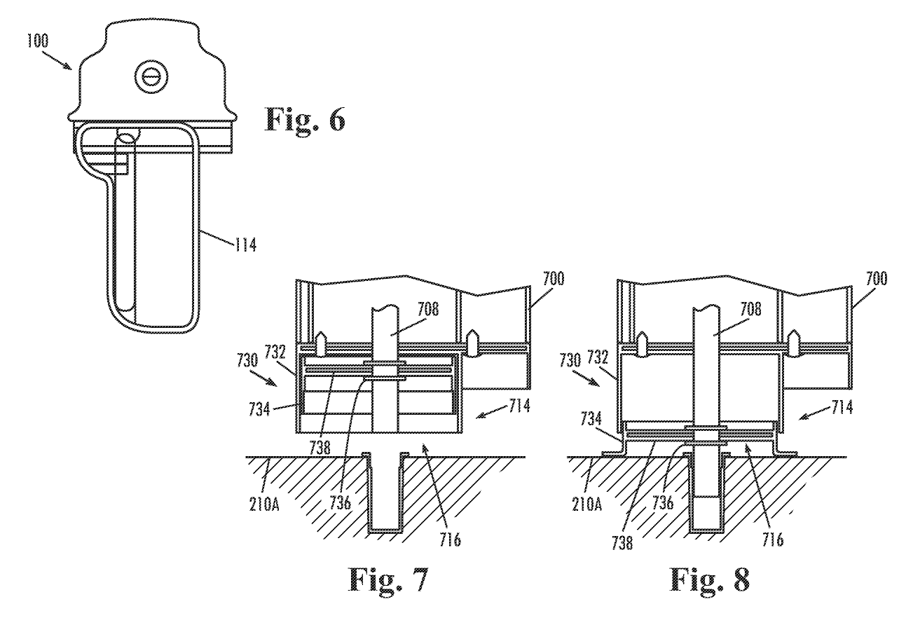

As mentioned above with reference to FIG. 2, the active door 200B may indirectly abut the outer portion 104 of the astragal 100 via the weather stripping 120. So that the weather stripping 120 does not drag against the floor as the inactive door 200A is opened, the weather stripping 120 may not extend into the relief area 218. Instead, the weather stripping 120 may stop at about the lower end of the astragal 100. In such cases, the expandable boot 114 may have a profile or outer shape that is selected to include the portion of the relief area 218 located below the weather stripping 120, as shown in FIG. 6. More specifically, the expandable boot 114 may be shaped to substantially fill the relief area 218 located below the rearward or inner portion 102 of the astragal 100 between the doors 100, and also located below the forward or outer portion 104 of the astragal 200 in the vicinity of the weather stripping 120. Such a profile may be selected to ensure the expandable boot 114 forms a tight and complete seal, although other profiles are possible in other embodiments.

The description above pertains to just one example embodiment of an astragal with an expandable boot, although other configurations are possible in other embodiments. For example, FIGS. 7 and 8 are partial side cross-sectional views of another embodiment of an astragal 700 with an expandable boot 714, with the expandable boot 714 shown in a compacted shape in FIG. 7 and an expanded shape in FIG. 8.

As shown, the expandable boot 714 may include telescoping walls 730. As shown the telescoping walls 730 may include fixed walls 732 and movable walls 734. The fixed walls 732 may be fixed in a vertical direction, and the movable walls 734 may be movable in the vertical direction. More specifically, the movable walls 734 may be associated with the locking rod bolt 708 or other actuating member via a flexible transfer structure 716. The flexible transfer structure 716 may transfer movement of the locking bolt 708 to the movable walls 734, to move the expandable boot 714 from the compacted shape to the expanded shape. In the illustrated embodiment, the fixed walls 732 are on the outside of the expandable boot 714 and the movable walls 734 are on the inside, although the configuration may be reversed or altered in other embodiments.

When the expandable boot 714 is in the compacted shape, the expandable boot 714 may be relatively “compacted” in the vertical direction. The movable walls 734 may be in a vertical upward position with reference to the fixed walls 732, such that the vertical height of the expandable boot 714 as a whole may be at a minimum. As shown in the illustrated embodiment, the movable walls 734 may actually may be extended, hanging freely under the force of gravity, and yet the vertical height may be at a minimum due the relatively elevated position of the movable walls 734 within the expandable boot 714.

As the expandable boot 714 moves from the compacted position to the expanded position, the vertical height of the expandable boot 714 may increase. More specifically, as the locking bolt 708 translates downward, the movable walls 734 may translate downward with reference to the fixed walls 732. At some point, the movable walls 734 may contact the lower sill 210A, such that the expandable boot 714 assumes the expanded shape. Thus, the vertical height of the expandable boot 714 in the expanded shape may be relatively greater than the vertical height of the expandable boot 714 in the compacted shape. With continued downward translation, the movable walls 734 may compress slightly against the lower sill 210A, forming a tight seal.

The flexible transfer structure 716 may have a range of configurations. For example, the flexible transfer structure 716 may include washers 736 attached to the locking bolt 708, and flexible shims 738 extending from the washers 736 to the movable walls 734. In use, flexible transfer structure 716 may transfer movement of the locking bolt 708 to the movable walls 734. More specifically, the washers 736 may translate with the locking bolt 708, and such translation may be transferred to the movable walls 734 through the flexible shims 738. Once the movable walls 734 contact the lower sill 210A, the flexible shims 738 may absorb at least a portion of the further displacement of the locking bolt 708, forming a tight seal against the lower sill 210A. The movable walls 734 may also partially flex with reference to the lower sill 210A, although other configurations are possible

While particular embodiments of an astragal with an expandable boot have been disclosed in detail in the foregoing description and figures for purposes of example, those skilled in the art will understand that variations and modifications may be made without departing from the scope of the disclosure. All such variations and modifications are intended to be included within the scope of the present disclosure, as protected by the following claims.

At least the following is claimed:

1. A system for selectively blocking an area at an end of an astragal, the system comprising:
an expandable boot positioned at the end of the astragal, the expandable boot movable between a compacted shape and an expanded shape; and
an actuator operable to move the expandable boot between the compacted shape and the expanded shape.

2. The system of claim 1, wherein the expandable boot comprises one or more of the following; accordion shaped walls and telescoping walls.

3. The system of claim 1, wherein the expandable boot comprises an internal spring.

4. The system of claim 3, wherein the internal spring transfers movement of the actuator to the expandable boot, causing the expandable boot to assume the expanded shape.

5. The system of claim 4, wherein the internal spring absorbs movement of the actuator after the expandable boot has assumed the expanded shape, sealing the expandable boot against an adjacent surface.

6. The system of claim 1, wherein the actuator is associated with a locking mechanism of the astragal.

7. The system of claim 1, wherein the expandable boot comprises an elastomeric material.

8. An astragal comprising:
an astragal jamb member;
an expandable boot coupled to an end of the astragal jamb member, the expandable boot movable between a compacted shape and an expanded shape; and
an actuating member extending from an end of the astragal, the actuating member movable between a retracted position and an extended position, the actuating member expanding the expandable boot as the actuating member moves from the retracted position to the extended position.

9. The astragal of claim 8, wherein the expandable boot comprises one ore more of the following: accordion shaped walls and telescoping walls.

10. The astragal of claim 8, wherein the expandable boot comprises an elastomeric material.

11. The astragal of claim 8, wherein the expandable boot comprises an internal spring.

12. The astragal of claim 11, wherein the internal spring is operable to transfer downward movement of the actuating member to the expandable boot to expand the expandable boot into the expanded shape, and the internal spring is further operable to absorb downward movement of the actuating member after the expandable boot has assumed the expanded shape to seal the expandable boot against an adjacent surface.

13. The astragal of claim 11, wherein the actuating member comprises a projecting flange positioned about the actuating member above the internal spring, the projecting flange transferring movement of the actuating member to the internal spring.

14. The astragal of claim 8, wherein the actuating member comprises a movable tip.

15. The astragal of claim 14, wherein the movable tip is operable to compact the expandable boot as the actuating member moves from the extended position to the retracted position, and wherein the movable tip is further operable to maintain the expandable boot in the compacted shape once the actuating member is in the retracted position.

16. The astragal of claim 14, wherein the movable tip is movable between an outwardly projecting position and an upwardly projecting position.

17. The astragal of claim 16, wherein the movable tip is sized to fit within a receiving well when the movable tip is in the upwardly projecting position.

18. The astragal of claim 8, further comprising an actuator operable to move the actuating member between the retracted position and the extended position.

19. The astragal of claim 17, wherein the actuator is associated with a spring that drives the actuating member into the extended position, the spring maintaining the expandable boot in the expanded shape once the actuating member is in the extended position.

20. The astragal of claim 8, wherein the actuating member is a locking bolt of a locking mechanism.
